(19) United States
(12) Patent Application Publication
(10) Pub. No.: US 2021/0150264 A1
(43) Pub. Date: May 20, 2021

(54) SEMI-SUPERVISED ITERATIVE KEYPOINT AND VIEWPOINT INVARIANT FEATURE LEARNING FOR VISUAL RECOGNITION

(71) Applicant: Siemens Aktiengesellschaft, Munich (DE)

(72) Inventors: Srikrishna Karanam, Plainsboro, NJ (US); Ziyan Wu, Princeton, NJ (US); Kuan-Chuan Peng, Plainsboro, NJ (US); Jan Ernst, Princeton, NJ (US)

(21) Appl. No.: 16/623,558

(22) PCT Filed: Jul. 3, 2018
(86) PCT No.: PCT/US2018/040668

§ 371 Date: Dec. 17, 2019

Related U.S. Application Data
(60) Provisional application No. 62/528,672, filed on Jul. 5, 2017.

(51) Int. Cl. G06K 9/62; G06K 9/00; G06K 9/46; G06T 15/10

(52) U.S. Cl. CPC G06K 9/6256; G06K 9/00208; G06T 15/10; G06K 9/4647; G06K 9/4671

(57) ABSTRACT

A system and method for semi-supervised learning of visual recognition networks includes generating an initial set of feature representation training data based on simulated 2D test images of various viewpoints with respect to a target 3D rendering. A feature representation network generates feature representation vectors based on processing of the initial feature representation training data. Keypoint patches are labeled according to a score value based on a series of reference patches of unique viewpoint poses and a test keypoint patch processed through the trained feature representation network. A keypoint detector network learns keypoint detection based on processing of the keypoint detector training data. Output of the keypoint detector network learning is used as refined training data for successive iterations of the feature representation network learning, and output of successive iterations of the feature representation network learning is used as refined training data for the keypoint detector learning until convergence.

### TECHNICAL FIELD

This application relates to artificial intelligence. More particularly, this application relates to applying artificial intelligence to a visual recognition system.

### BACKGROUND

Visual recognition systems can be used for image analytics applications like image search and retrieval. There are problems to overcome in such applications, including image registration, 2D/3D object recognition, and pose estimation.

Computer vision systems may extract features detected in images for comparison to known features stored as feature vectors in a data library, where the set of all possible feature vectors is organized as a feature space. When enough features are matched, the object in the image can be classified according to classification training imposed on the network. The feature space used to represent images in applications such as object recognition and pose estimation plays a critical role for generating training data to be used during a machine learning process. Specifically, in real-world scenarios, test images captured by sensors are often cluttered with spurious background and noise, regardless of image modalities. Such factors can play a mitigating role in the success of an automatic system to recognize objects or estimate pose of objects. For instance, using a global feature representation for the entire image would likely consider these noise sources, resulting in an inaccurate feature space representation of the image. In summary, conventional training of visual recognition systems fail to automatically detect accurate features in conjunction with learning feature representations, particularly when test images include sensor noise.

### SUMMARY

Aspects according to embodiments of the present disclosure include a process and a system to automatically learn feature representations and detect keypoints in image data using an end-to-end machine learning process. The image data can be of any modality, including RGB images or depth images for example. The process proceeds in an iterative fashion, updating and refining the feature representation and keypoint detection in each round until convergence, where keypoints may be defined as points in an image best suited for object recognition analysis by a computer vision process.

In an initialization cycle, given a 3D rendering of a physical environment (e.g., a CAD rendering of a system of components which are target objects for object recognition), random 2D images of various viewpoint poses may be rendered to simulate various perspectives useful for finding candidate keypoints. The rendered images may be used to generate training data for learning viewpoint invariant feature representations from which keypoints may be generated. For example, given a test image having viewpoint pose information, a point in the image may be randomly sampled and a correspondence in a rendered image of another pose may be determined. The rendered image may be generated by perturbing the given pose of the test image. Locating local patches around the two corresponding points may generate a pair of similar patches, which may train a convolutional neural network to learn a feature representation that is viewpoint invariant. Sample keypoints may be randomly selected from a test image, and compared to random keypoints of reference images to generate data to train a keypoint detector network. The previously trained feature representation network may be used to process each candidate keypoint and reference keypoint for assigning a score to the candidate keypoint. This score is representative of two key properties of keypoints: repeatability and uniqueness. The data generated in this fashion may be used to train the keypoint detector network. After the feature representation network and the keypoint detector network are trained by the initialization phase, an iterative refinement may be performed in subsequent cycles. Using the keypoint detector, keypoints in the images may be detected and patches may be sampled around these keypoints. These patches may be used as input to refine the feature representation network. This iterative procedure of refining the feature representation network and keypoint detector network may be repeated until convergence.

The advantage of iterative process of keypoint detection and feature representations in a circular manner for semi-supervised training of the machine learning networks is for efficient and automatic generation of labeled training data without the cost and effort of manual/expert label generation, while circumventing the issues of noisy training images captured by cameras commonly used in conventional applications.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows a flow diagram of a vision recognition learning process in accordance with one or more embodiments of the disclosure.

FIG. 2 shows an example of an engine for simulating patch pairs from randomly selected keypoints in accordance with one or more embodiments of the disclosure.

FIG. 3 is a diagram that shows an example of locating correspondence for generation of patch pairs using the engine shown in FIG. 2.

FIG. 4 shows an example of a system for feature representation network training in accordance with one or more embodiments of the disclosure.

FIG. 5 shows an example of a system for keypoint detector network training in accordance with one or more embodiments of the disclosure.

FIG. 6 shows an example of a modular structure for a system to learn keypoint detection and feature representation in accordance with one or more embodiments of the disclosure.

FIG. 7 shows an example of object recognition application by a system trained in accordance with one or more embodiments of the disclosure.

FIG. 8 shows an exemplary computing environment within which embodiments of the disclosure may be implemented.

### DETAILED DESCRIPTION

Methods and systems are disclosed for visual recognition of objects in images using machine learning to train a first network to detect strong localized features, called keypoints, in the presence of image noise caused by visual sensors. Conventional object recognition systems that employ keypoint matching are hindered by sensor noise and tend to identify weak keypoints that may be representative of a feature influenced by the noise instead of an actual physical feature of the target object. A second network may be trained by machine learning to determine viewpoint invariant feature representations of patches around the detected keypoints in a target image. The advantage of viewpoint invariance is to enhance recognition of regions in a target image which correspond to stored feature representations of the regions in an inventory library where the stored feature representations may be of a viewpoint not identical to the target image. Multiple cycles of keypoint detection and feature representation generation may be applied to the first and second networks for learning refinement until convergence. Application of the trained first and second networks of the visual recognition system include processing input images to find strong keypoints within the images, identify the feature representations of the images based on the keypoints, and identify objects in the image based on matching the feature representations to a library of objects indexed by the features.

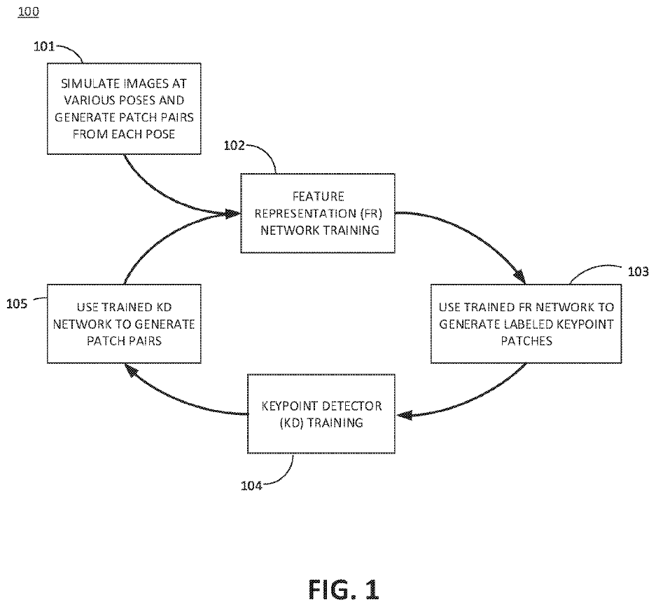

FIG. 1 is a flow diagram of a visual recognition learning process in accordance with one or more embodiments of the disclosure. The visual recognition system of the present disclosure may apply neural networks, such as convolutional neural networks, which may learn keypoint detection and feature representations. In an embodiment, a learning process 100 is configured as a cyclical process to generate training data for the neural networks, detect keypoints, and generate feature representations for image data. To initialize the learning of the neural networks, an initial set of data is generated at stage 101. Given a 3D rendering, such as an engineering design rendering of an object or a system of components, sample images may be rendered as simulated 2D viewpoint poses (e.g., simulated photos from a virtual camera). For each simulated image, random patch samples may be selected to as localized regions of the image for detecting keypoints for visual recognition. In order to drive learning viewpoint invariant recognition, a perturbed version of the patch (i.e., having a slight viewpoint variation) is generated to create a pair of similar patches having a corresponding keypoint. With knowledge gained from locating the corresponding keypoint, one or more random keypoints on the perturbed patch version may be selected as known dissimilar keypoints, and dissimilar patches may be defined at these points. At stage 102, a feature representation network may then be trained by feeding the patch pairs, labeled or tagged to indicate either ‘similar’ or ‘dissimilar’ during the correspondence process, whereby the feature representation network is trained to learn feature vector generation for a given keypoint patch. At stage 103, training data is generated and stored for use in machine learning by a keypoint detector network at stage 104. To generate the training data at stage 103, the trained feature representation network may process random keypoint samples of images and assign scores to each processed keypoint by comparison to reference keypoints. Keypoints may then be labeled according to their corresponding score value for use as training data. During training of the keypoint detector network at stage 104, the labeled keypoints may be input to the network. The learning of the keypoint detector network is semi-supervised since the labels were generated without manual assistance or tagging using human expertise. An advantage of the iterative learning process of this disclosure is eliminating the need for a source of labeled training images, such as photos or other images obtained by cameras or vision sensors, which may be corrupted by sensor noise and interference. With both neural networks trained, additional cycles of the process 100 for the visual recognition system may be executed iteratively to refine the machine learning by feeding labeled keypoints from the keypoint detector network to the feature representative network, and determining stronger keypoints with each iteration of the learning by the feature representation network. The next cycle begins at stage 105, in which one or more rendered images may be processed by the trained keypoint detector to process patches to determine keypoints and corresponding score values. Patch pairs may be generated and labeled according to the score values as refined training data for refined learning by the trained feature representation network at a second iteration of stage 102. For example, patches with high scores (e.g., score value 0.5<S<=1) may be paired to be labeled as similar patch pairs, and patches with low scores (e.g., 0<S<=0.5) may be paired to be labeled as dissimilar patch pairs. Various ranges may be set for high and low scores, including but not limited to 0<S<=0.7 for low score and 0.7<S<1 for high score. Successive cycles of process 100 may be repeated until a convergence is reached. In an embodiment, accuracy of the trained networks may be evaluated with a validating dataset to verify convergence.

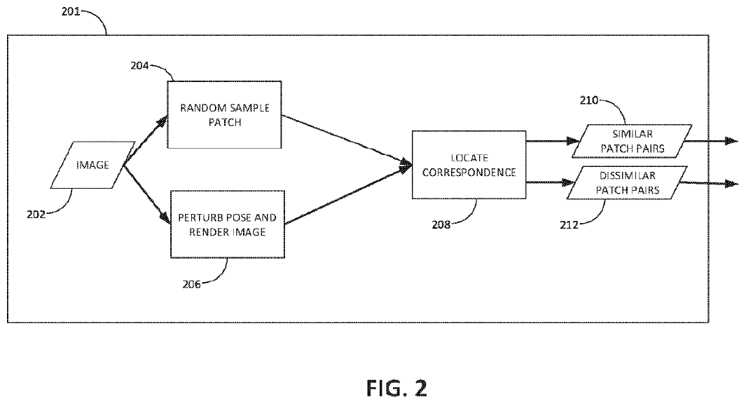

FIG. 2 shows an example of an engine for simulating patch pairs from randomly selected keypoints in accordance with one or more embodiments of the disclosure. Training data engine 201 is configured to generate multiple rendered images 202 having various viewpoint poses associated with a virtual image sensor (e.g., a virtual camera). For example, given a 3D CAD rendering of a target object or set of objects, engine 201 may generate various 2D renderings from different perspectives. From each image 202, pairs of patches may be generated as training data for the feature representation network, corresponding with stage 101 shown in FIG. 1. In an embodiment, training data engine 201 may select a rendered image 202, select a first sample random patch 204, render an image 206 from a perturbed pose with respect to the random patch 204, locate correspondence of patch pairs 208, and identify similar patch pairs 210 and dissimilar patch pairs 212. For each rendered image 202, multiple random patches 204 may be selected. In an embodiment, a keypoint may be defined as a center point of a patch. For example, a patch may be defined by a 100×100 pixel region surrounding a keypoint. For each image 202, a corresponding perturbed pose image 206 may be rendered. A correspondence algorithm may locate a corresponding keypoint 208 in the perturbed image that has a depth correspondence with the keypoint in the random patch 204. From the corresponding keypoint, a patch may be defined around the keypoint, and the two patches may be output as a similar patch pair 210. Using the knowledge of where the corresponding keypoint is located, alternative keypoints may be randomly selected on the perturbed image 206 anywhere other than the patch identified for the similar patch pair 210. Patches defined around the alternative keypoints may be paired with sample patch 204 to generate dissimilar patch pairs 212. This process may be repeated for each rendered image 202 to produce a large set of similar patch pairs 210 and dissimilar patch pairs 212, which may be used as labeled training input for machine learning of the feature representation network.

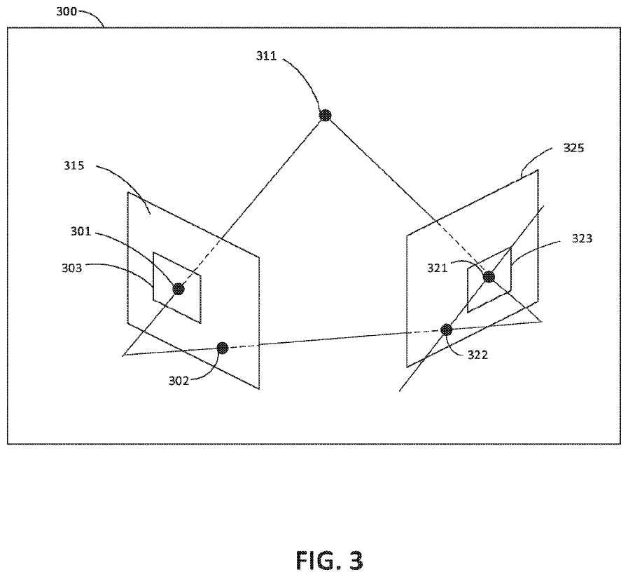

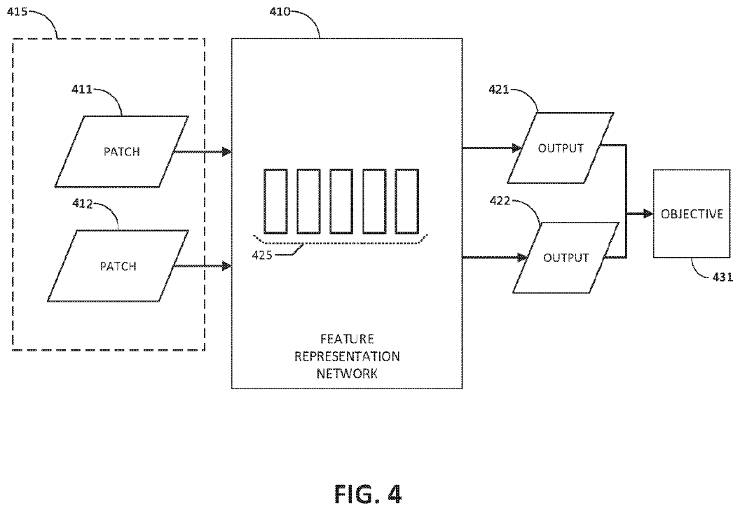

FIG. 3 is a diagram that shows an example of locating correspondence for generation of patch pairs, corresponding to block 208 of the engine 201 shown in FIG. 2. In an embodiment, correspondence engine 300 may apply epipolar geometry using known depth information of the 3D rendering associated with a selected keypoint 301 of a 2D rendered image 315. For example, a randomly selected keypoint 301 may be selected for rendered image 315. Depth information corresponding with the keypoint based on the original 3D rendering may be back-projected as point 311. For example, pose information associated with the virtual image sensor that generated the 2D rendered image 315 may provide the location of the projected point 311. An image 325 may be rendered based on a perturbed pose with respect to image 315. For example, a different viewpoint may be selected and from that viewpoint, 2D image 325 may be rendered. The location of corresponding keypoint 321 may be projected onto the 2D plane of image 315 by applying an epipolar solution, which may be based on points 302, 322 and 311. A corresponding patch 323 may be defined around corresponding keypoint 321. Patch 303 around keypoint 301 may be paired with corresponding patch 323 and labeled as a similar patch pair (e.g., tagged with value “1”), having established a common correspondence point 311 by a perturbed pose. Accordingly, the correspondence engine 300 forces similar patch pair generation, and provides labeled patch pairs known to be strong matches between two 2D image keypoints of different viewpoints corresponding to a common point in the 3D model. Correspondence engine 300 may generate and label dissimilar patch pairs (e.g., tagged with value “0”) by selecting keypoints located elsewhere in rendered image 325 (i.e., outside of patch region 323), and pairing with keypoint 301, with the knowledge that such alternative keypoints lack depth correspondence with point 311. FIG. 4 shows an example of a block diagram for feature representation network training in accordance with one or more embodiments of the disclosure. In an embodiment, a feature representation network, such as a convolutional neural network 410, may be trained to learn feature representations of images. The network 410 may have layers 425, which may include or omit one or more of the following layer types: convolutional layers, non-linear activation layers, max-pooling layers, and fully connected layers. Learning by convolutional neural network processing may include a forward pass with back propagation. During the training, the network 410 may process a patch pair 415 as input to a convolutional neural network. In an embodiment, the network 410 may operate using a Siamese convolutional neural network operation. Patch pair 415 may be selected from a pool of generated similar patch pairs and dissimilar patch pairs, such as patch pairs 210, 211 shown in FIG. 2. For example, a patch pair with a first patch 411 may be fed to the network 410 to produce a feature vector output 421. The second patch of the patch pair is shown as patch 412, which may be fed to the network 410 to produce a feature vector output 422. An objective function 431 may compare the feature vector outputs 421, 422 to produce an objective value, which may be a single scalar value to be minimized as the training proceeds for similar patch pairs. For example, when processing a similar patch pair 415, the objective function may return a low value as an indication that feature vectors of n dimensions of the vector outputs 421, 422 are very similar for a common keypoint having different patch viewpoints. As such, neural network 410 learns viewpoint invariant feature representations for a given keypoint. The objective function 431 may be implemented by alternative functions which determine an error from actual or expected values, such as a distance vector or value. As enough patch pairs 415 are processed, adjustments to weights and bias values of the convolutional neural network 410 may be made until a convergence of training and validation accuracy is observed. In another embodiment, the network 410 may consist of two identical sets of layer 425 operations, whereby the patch pair 415 is processed together in parallel, and the objective function is a last layer of network 410. During the learning process of network 410, multiple feature vectors are generated and stored for the next phases of the iterative training of the keypoint detector network.

Training data for the keypoint detector network may be generated to produce labeled keypoints. In an embodiment, random keypoints may be matched using the trained feature representation network 410. For example, given a test image with pose information, and a randomly selected test keypoint for which a score label is to be assigned, the test image may be randomly perturbed to obtain P unique viewpoint poses (e.g., P=100). Next, a set of P reference patches may be randomly sampled, one in each of the P viewpoint poses. Given a patch around the test keypoint in the test image, a test feature representation (i.e., a test feature vector) may be generated using the feature representation network 410. For example, the test keypoint patch may be fed as patch 411 to the network 410 to generate and output 421 in the form of a feature vector. Next, each of the P reference patches may be fed to the feature representation network 410 (e.g., as patch 411) to generate P corresponding feature vectors (e.g., output 421), respectively. A feature space distance between the test patch and the P reference patches may be computed, resulting in a P-dimensional distance vector. For example, an objective function 431 may produce a scalar value for each distance comparison and generate a distance vector using the set of distance values. The P-dimensional distance vector may be used in conjunction with a scoring scheme to identify the uniqueness and repeatability of the test keypoint in the test image. Specifically, the distribution of the distance vector may be stored as a histogram with a particular bin size (e.g., 0.1). A scoring scheme may admit a score value S, defined by the following equation:

S=1−(k/N) Equation 1

where
k is number of elements in a first bin,
N is dimension of distance vector
   According to Equation 1, score value S may range between 0 and 1, incremented by bin size (e.g., 0.1). Since the first bin represents the smallest distance, first bin values are a strong indicator of a match. Higher scores may be assigned to test keypoints with fewer distances in the first bin, which indicates uniqueness by minimal numbers of matches. Under this scoring scheme, repeatability is demonstrated by identification of a match for the test keypoint against a previously stored patch.

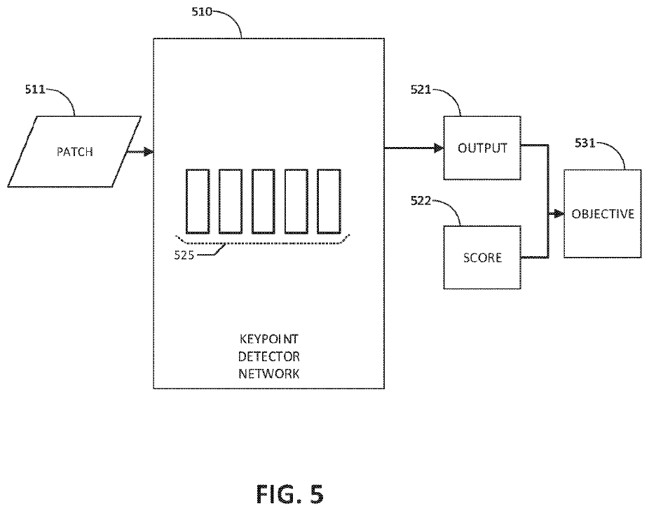

FIG. 5 shows an example of a system for keypoint detector network training in accordance with one or more embodiments of the disclosure. Learning by a keypoint detector network 510 may be executed by receiving a labeled keypoint patch 511, labeled by a score 522 determined by the process described above. Keypoint detector network 510 may include a number of layers 525, which may include or omit one or more of the following layer types: convolutional layers, non-linear activation layers, max-pooling layers, and fully connected layers. The network 510 may be implemented as convolutional neural network that processes inputs in a forward pass and a backward propagation. Labeled keypoint patches 511 may be fed to the keypoint detector network 510 in order to learn recognition of strong keypoints when given a test image. For example, when keypoints with high scores are processed by network 510, the objective function 531 may compare score value at output 521 to the actual score value 522 from the label information. The learning by network 510 (i.e., layer parameter adjustments based on forward and backward propagation) is then based on the training data of keypoint patch scores, which may include patches for both strong keypoints and weak keypoints. Objective function 531 may be based on a distance based function, such as a Euclidean loss, which may be a single scalar value output.

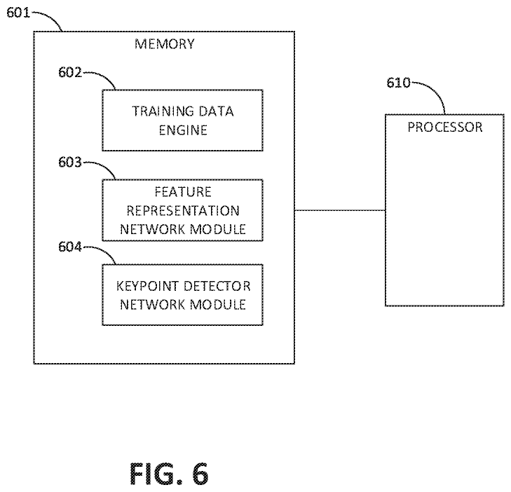

FIG. 6 shows an example of a modular structure for a system to learn keypoint detection and feature representation in accordance with one or more embodiments of the disclosure. Memory 601 may include various program modules configured to execute instructions, including a training data engine 602, a feature representation network module 603, and a keypoint detector network module 604. In an embodiment, training data engine 602 may include algorithms to generate training data used for machine learning of the feature representation network module 603, as described above with respect to FIG. 2, whereby the training data enables the feature representation network module 603 to determine viewpoint invariant feature representation vectors of patches of test images. The feature representation network module 603 may generate training data for the keypoint detector network by processing test keypoint patches and reference patches to generate keypoint score values S according to equation 1 as described above, which provide labeled keypoint patches. The keypoint detector network module 604 may execute learning by a convolutional neural network by processing the keypoint detector training data, including the labeled keypoint patches generated by the feature representation network module 603. The keypoint detector network module 604 may generate refined training data for the feature representation network module 603. Test images may be processed by the trained keypoint detector network to generate keypoint patches with score information. Patches with high scores may be paired to be labeled as similar patch pairs, and patches with low scores may be paired to be labeled as dissimilar patch pairs for refined training data inputs to the feature representation network module 603.

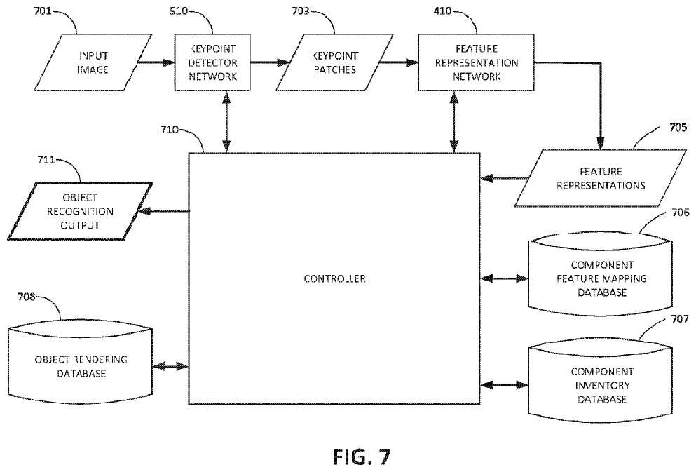

FIG. 7 shows an example of object recognition application by a system trained in accordance with one or more embodiments of the disclosure. In an embodiment, the method and system of the present disclosure may be applied to images of a target system of components captured by an image sensing device, whereby the components may be identified by the trained visual detection system and may be linked to an inventory database of the components for replacement as required to remedy a defective component of the target system. As shown in FIG. 7, a controller 710, such as a computer processor, may access the keypoint detector network 510, the feature representation network 410, feature representation data 705, a component feature mapping database 706, and a component inventory database 707. Following the iterative learning of the keypoint detector network 510 and the feature representation network 410 in accordance with the embodiments of the disclosure, the controller 710 may operate the trained networks for processing input image 701 to perform object recognition. For example, the keypoint detector network 510 may receive an input image of target objects and identify keypoint patches 703 based on the previous training. The feature representation network 410 may receive the keypoint patches and identify feature representations 705 based on matching the keypoints to learned feature representations. The controller may match the feature representation information, such as rotation and translation vector data mapped to the features, to the component feature mapping database 706 and identify corresponding objects from the component inventory database 707 and/or the object rendering database 708. The object recognition output 711 may be a list of identified objects based searching the component inventory database 707. In another embodiment, the object recognition output may be based on the controller 710 search of the object rendering database 708.

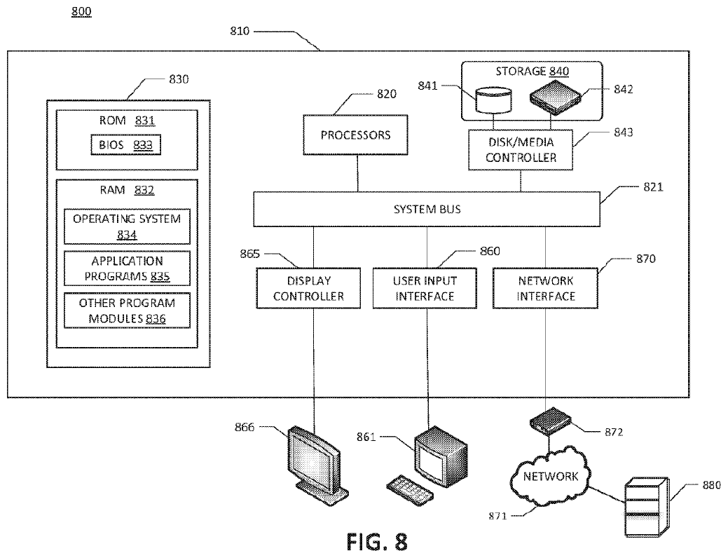

FIG. 8 shows an exemplary computing environment within which embodiments of the disclosure may be implemented. As shown in FIG. 8, the computer system 810 may include a communication mechanism such as a system bus 821 or other communication mechanism for communicating information within the computer system 810. The computer system 810 further includes one or more processors 820 coupled with the system bus 821 for processing the information.

The processors 820 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 820 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 821 may include at least one of a system bus, a memory bus, an address bus, or a message bus, and may permit exchange of information (e.g., data (including computer-executable code), signaling, etc.) between various components of the computer system 810. The system bus 821 may include, without limitation, a memory bus or a memory controller, a peripheral bus, an accelerated graphics port, and so forth. The system bus 821 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 8, the computer system 810 may also include a system memory 830 coupled to the system bus 821 for storing information and instructions to be executed by processors 820. The system memory 830 may include computer readable storage media in the form of volatile and/or nonvolatile memory, such as read only memory (ROM) 831 and/or random access memory (RAM) 832. The RAM 832 may include other dynamic storage device(s) (e.g., dynamic RAM, static RAM, and synchronous DRAM). The ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system 833 (BIOS) containing the basic routines that help to transfer information between elements within computer system 810, such as during start-up, may be stored in the ROM 831. RAM 832 may contain data and/or program modules that are immediately accessible to and/or presently being operated on by the processors 820. System memory 830 may additionally include, for example, operating system 834, application programs 835, and other program modules 836.

The operating system 834 may be loaded into the memory 830 and may provide an interface between other application software executing on the computer system 810 and hardware resources of the computer system 810. More specifically, the operating system 834 may include a set of computer-executable instructions for managing hardware resources of the computer system 810 and for providing common services to other application programs (e.g., managing memory allocation among various application programs). In certain example embodiments, the operating system 834 may control execution of one or more of the program modules depicted as being stored in the data storage 840. The operating system 834 may include any operating system now known or which may be developed in the future including, but not limited to, any server operating system, any mainframe operating system, or any other proprietary or non-proprietary operating system.

The application programs 835 may a set of computer-executable instructions for performing the iterative keypoint and viewpoint invariant feature learning for visual recognition process in accordance with embodiments of the disclosure.

The computer system 810 may also include a disk/media controller 843 coupled to the system bus 821 to control one or more storage devices for storing information and instructions, such as a magnetic hard disk 841 and/or a removable media drive 842 (e.g., floppy disk drive, compact disc drive, tape drive, flash drive, and/or solid state drive). Storage devices 840 may be added to the computer system 810 using an appropriate device interface (e.g., a small computer system interface (SCSI), integrated device electronics (IDE), Universal Serial Bus (USB), or FireWire). Storage devices 841, 842 may be external to the computer system 810, and may be used to store image processing data in accordance with the embodiments of the disclosure.

The computer system 810 may also include a display controller 865 coupled to the system bus 821 to control a display or monitor 866, such as a cathode ray tube (CRT) or liquid crystal display (LCD), for displaying information to a computer user. The computer system includes a user input interface 860 and one or more input devices, such as a user terminal 861, which may include a keyboard, touchscreen, tablet and/or a pointing device, for interacting with a computer user and providing information to the processors 820. The display 866 may provide a touch screen interface which allows input to supplement or replace the communication of direction information and command selections by the user terminal device 861.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium, such as the magnetic hard disk 841 or the removable media drive 842. The magnetic hard disk 841 may contain one or more data stores and data files used by embodiments of the present invention. The data store may include, but are not limited to, databases (e.g., relational, object-oriented, etc.), file systems, flat files, distributed data stores in which data is stored on more than one node of a computer network, peer-to-peer network data stores, or the like. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processors 820 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 841 or removable media drive 842. Non-limiting examples of volatile media include dynamic memory, such as system memory 830. Non-limiting examples of transmission media include coaxial cables, copper wire, and fiber optics, including the wires that make up the system bus 821. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 800 may further include the computer system 810 operating in a networked environment using logical connections to one or more remote computers, such as remote computing device 880. The network interface 870 may enable communication, for example, with other remote devices 880 or systems and/or the storage devices 841, 842 via the network 871. Remote computing device 880 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to system bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computing device 880). The network 871 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

It should be appreciated that the program modules, applications, computer-executable instructions, code, or the like depicted in FIG. 8 as being stored in the system memory 830 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 810, the remote device 880, and/or hosted on other computing device(s) accessible via one or more of the network(s) 871, may be provided to support functionality provided by the program modules, applications, or computer-executable code depicted in FIG. 8 and/or additional or alternate functionality. Further, functionality may be modularized differently such that processing described as being supported collectively by the collection of program modules depicted in FIG. 8 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 8 may be implemented, at least partially, in hardware and/or firmware across any number of devices.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f), unless the element is expressly recited using the phrase “means for.”

1. A system for semi-supervised learning of visual recognition networks, comprising:
at least one storage device storing computer-executable instructions configured as one or more modules; and
at least one processor configured to access the at least one storage device and execute the instructions, wherein the modules comprise:
a training data engine configured to generate an initial set of feature representation training data comprising randomly selected patch pairs generated from simulated 2D images of various viewpoints with respect to a target 3D rendering;
a feature representation network module configured to learn generation of feature representation vectors based on a convolutional neural network processing of the initial feature representation training data during a first stage, and configured to generate keypoint detector training data during a second stage, wherein the keypoint detector training data includes keypoint patches labeled according to a score value, wherein the score value is generated by processing through the feature representation network a series of reference patches randomly sampled from unique viewpoint poses determined by randomly perturbing a test image and a test keypoint patch determined as a patch around a randomly selected keypoint from the test image following training by the initial feature representation training data, the score value indicative of a distance vector corresponding to comparative distance between a feature vector of the test keypoint patch and feature vectors of the respective reference patches; and
a keypoint detector network module (604) configured to learn keypoint detection for a given test image based on a convolutional neural network processing of the keypoint detector training data,
wherein output of the keypoint detector network learning is used as refined training data for successive iterations of the feature representation network learning, and output of successive iterations of the feature representation network learning is used as refined training data for the keypoint detector learning until convergence.

2. The system of claim 1, wherein the training data engine generates the initial feature representation training data by simulating a perturbed pose image for each of the 2D test images, locating a corresponding keypoint in the perturbed pose image, identifying similar patch pairs and dissimilar patch pairs based on the corresponding keypoint location, and labeling the patch pairs according to the pairing.

3. The system of claim 2, wherein training data engine is configured to apply epipolar geometry using known depth information of the 3D rendering to determine location of the corresponding keypoint.

4. The system of claim 1, wherein the feature representation network module generates keypoint training data by executing a binning algorithm to generate a histogram for tracking scores the test keypoint patches.

5. The system of claim 4, wherein a keypoint patch is labeled with a score based on presence of an element in a first bin of the histogram indicating uniqueness and repeatability of the keypoint.

6. The system of claim 4, wherein the refined training data for successive iterations of the feature representation network learning comprises patch pairs generated by the keypoint detector network following at least one iteration of learning by the keypoint detector network, the patch pairs generated by pairing patches of high scores as similar patch pairs and pairing patches of low scores as dissimilar patch pairs.

7. The system of claim 1, wherein the feature representation network module executes a Siamese convolutional neural network configured to process the patch pairs, the network comprising an objective function layer configured to determine a scalar value to be minimized for similar patch pairs.

8. The system of claim 1, further comprising:
a component feature mapping database; and
a component inventory database;
wherein following training of the keypoint detector network and the feature representation network,
the keypoint detector module is configured to receive an input image and generate keypoint patches with score values,
the feature representation network module is configured to receive the keypoint patches with score values and generate feature representation vectors, and
the processor is configured to receive the feature representations and correlate feature representations with components in the component feature mapping database, identify objects from the component inventory database corresponding to the components, and output an object recognition output.

9. A method for semi-supervised learning of visual recognition networks, comprising:
generating, by a training data engine, an initial set of feature representation training data comprising randomly selected patch pairs generated from simulated 2D images of various viewpoints with respect to a target 3D rendering;
generating, by a feature representation network module, feature representation vectors based on a convolutional neural network processing of the initial feature representation training data during a first stage, and keypoint detector training data during a second stage, wherein the keypoint detector training data includes keypoint patches labeled according to a score value, wherein the score value is generated by processing through the feature representation network a series of reference patches randomly sampled from unique viewpoint poses determined by randomly perturbing a test image and a test keypoint patch determined as a patch around a randomly selected keypoint from the test image following training by the initial feature representation training data, the score value indicative of a distance vector corresponding to comparative distance between a feature vector of the test keypoint patch and feature vectors of the respective reference patches; and
learning, by a keypoint detector network module, keypoint detection for a given test image based on a convolutional neural network processing of the keypoint detector training data,
wherein output of the keypoint detector network learning is used as refined training data for successive iterations of the feature representation network learning, and output of successive iterations of the feature representation network learning is used as refined training data for the keypoint detector learning until convergence.

10. The method of claim 1, wherein the training data engine generates the initial feature representation training data by simulating a perturbed pose image for each of the 2D test images, locating a corresponding keypoint in the perturbed pose image, identifying similar patch pairs and dissimilar patch pairs based on the corresponding keypoint location, and labeling the patch pairs according to the pairing.

11. The method of claim 10, further comprising applying epipolar geometry using known depth information of the 3D rendering to determine location of the corresponding keypoint.

12. The method of claim 9, wherein generating keypoint training data comprises executing a binning algorithm to generate a histogram for tracking scores the test keypoint patches.

13. The method of claim 12, wherein a keypoint patch is labeled with a score based on presence of an element in a first bin of the histogram indicating uniqueness and repeatability of the keypoint.

14. The method of claim 12, wherein the refined training data for successive iterations of the feature representation network learning comprises patch pairs generated by the keypoint detector network following at least one iteration of learning by the keypoint detector network, the patch pairs generated by pairing patches of high scores as similar patch pairs and pairing patches of low scores as dissimilar patch pairs.

15. The method of claim 9, wherein the feature representation network module executes a Siamese convolutional neural network configured to process the patch pairs, the network comprising an objective function layer configured to determine a scalar value to be minimized for similar patch pairs.
